(19) United States
(12) Patent Application Publication
(10) Pub. No.: US 2020/0403816 A1
(43) Pub. Date: Dec. 24, 2020

(54) UTILIZING VOLUME-BASED SPEAKER ATTRIBUTION TO ASSOCIATE MEETING ATTENDEES WITH DIGITAL MEETING CONTENT

(71) Applicant: Dropbox, Inc., San Francisco, CA (US)

(72) Inventors: Shehzad Daredia, San Francisco, CA (US); Behrooz Khorashadi, Mountain View, CA (US)

(21) Appl. No.: 16/587,647

(22) Filed: Sep. 30, 2019

Related U.S. Application Data
(60) Provisional application No. 62/865,635, filed on Jun. 24, 2019.

(51) Int. Cl. H04L 12/18; G06K 9/00

(52) U.S. Cl. CPC H04L 12/1822; H04L 12/1818; G06K 9/00241; G06K 9/00255; H04L 12/1831

(57) ABSTRACT

The present disclosure relates to associating digital meeting content with meeting attendees based on volume-based speaker attribution. In particular, the disclosed systems can attribute segments of audio associated with a meeting to meeting attendees (i.e., identify a meeting attendee as the speaker of one or more audio segments) based on speaking volumes captured by the audio. For example, the audio of a meeting can include speech from a plurality of meeting attendees, where the speech associated with each meeting attendee corresponds to a particular speaking volume. The disclosed systems can use the speaking volumes to map speakers to meeting attendees, therefore associating the meeting attendees with particular segments of speech. The disclosed systems can then associate digital meeting content with those meeting attendees.

### CROSS-REFERENCE TO RELATED APPLICATIONS

This application claims the priority to and the benefit of U.S. Provisional Patent Application No. 62/865,635, filed Jun. 24, 2019, which is incorporated herein by reference in its entirety.

### BACKGROUND

Recent years have seen significant advancements in hardware and software platforms that improve the ability for attendees of a meeting to distribute information and contribute to workflow. For example, conventional systems can analyze an audio recording of a meeting and generate a transcript based on the analysis. Some conventional systems can perform further analysis to identify one of the meeting attendees as the speaker of one or more segments of the audio recording. The conventional systems can then associate transcript content with the identified speaker accordingly (e.g., identify the meeting attendee as the speaker within the transcript).

Despite these advances, however, conventional systems suffer from several technological shortcomings that result in inefficient, inflexible, and inaccurate operation. For example, conventional speaker attribution systems are often inefficient in that they employ computationally expensive models to identify speakers captured in an audio recording. To illustrate, many conventional speaker attribution systems employ models that identify a speaker of audio segments based on a vocal signature (i.e., a “vocal fingerprint” or “voiceprint”) captured by the audio recording. Such models typically require a training process that allows the models to identify the vocal characteristics or attributes that make up the voiceprint of a particular speaker. Accordingly, the conventional systems often require a significant amount of computing resources (e.g., time, processing power, and computing memory) to train these models.

In addition to efficiency concerns, conventional speaker attribution systems are also inflexible. In particular, because conventional speaker attribution systems identify speakers using models trained to recognize the speakers based on voiceprints, such systems are often inflexible in that they rigidly require a particular meeting attendee's voiceprint data to be submitted to the system in order to identify that meeting attendee as a speaker. Consequently, the conventional systems often fail to flexibly identify meeting attendees as speakers if those meeting attendees have not submitted their corresponding voiceprint data (e.g., the meeting attendees are new users).

In addition to problems with efficiency and flexibility, conventional speaker attribution systems are also inaccurate. In particular, because speaker attribution systems identify speakers using models trained based on submitted voiceprint data, such systems typically fail to identify (or may misidentify, depending on how the system is configured) a meeting attendee as a speaker if the model has not been trained to recognize the voice of that particular meeting attendee. Consequently, the conventional systems may fail to accurately associate digital meeting content with the correct meeting attendees.

These, along with additional problems and issues, exist with regard to conventional speaker attribution systems.

### SUMMARY

One or more embodiments described herein provide benefits and/or solve one or more of the foregoing or other problems in the art with systems, methods, and non-transitory computer readable storage media that accurately associate digital meeting content with meeting attendees based on flexible volume-based speaker attribution. In particular, the disclosed systems can attribute segments of audio associated with a meeting to meeting attendees (i.e., identify a meeting attendee as the speaker of one or more audio segments) based on speaking volumes captured in the audio. For example, the audio of a meeting can include speech from a plurality of meeting attendees, where the speech associated with each meeting attendee corresponds to a particular speaking volume. The disclosed systems can use the speaking volumes to map speakers to meeting attendees and then associate digital meeting content with the meeting attendees based on the mapping. In this manner, the disclosed systems can flexibly identify meeting attendees as speakers and accurately associate digital meeting content with those meeting attendees.

To illustrate, in one or more embodiments, a system can receive audio data from a plurality of client devices, where the audio data includes audio content associated with a meeting. The system can analyze the audio data to determine a primary speaking volume (e.g., a highest speaking volume) associated with a first client device. Accordingly, the system associates a user of the first client device with a segment of the audio content based on the primary speaking volume associated with the first client device. The system can then generate a digital meeting item (e.g., an action item) based on a transcript of the segment of the audio content and associate the meeting item with the user of the first client device (e.g., send an action item prompt to the user) based on the association between the user and the segment of audio content.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a speaker attribution system can operate in accordance with one or more embodiments;

FIG. 2 illustrates a block diagram for associating digital meeting items with a user associated with a meeting in accordance with one or more embodiments;

FIG. 3 illustrates a diagram of a physical environment in which a meeting involving a plurality of users occurs in accordance with one or more implementations;

FIG. 4 illustrates a block diagram for associating digital meeting items with a user associated with a meeting in accordance with one or more embodiments;

FIG. 5 illustrates a block diagram for using video data to associate digital meeting items with a user in accordance with one or more embodiments;

FIG. 6 illustrates a diagram of a physical environment for a meeting in which two client devices are used to record audio content and volume data separately in accordance with one or more embodiments;

FIGS. 7A-7C each illustrate a user interface through which the speaker attribution system can provide a digital meeting item associated with a user in accordance with one or more embodiments;

FIG. 8 illustrates an example schematic diagram of a speaker attribution system in accordance with one or more embodiments;

FIG. 9 illustrates a flowchart of a series of acts for associating a digital meeting item with a user associated with a meeting in accordance with one or more embodiments;

FIG. 10 illustrates a block diagram of an exemplary computing device in accordance with one or more embodiments; and

FIG. 11 illustrates a networking environment of an online content management system in accordance with one or more embodiments.

### DETAILED DESCRIPTION

One or more embodiments described herein include a speaker attribution system that utilizes flexible volume-based speaker attribution to accurately identify speakers in a meeting and associate digital meeting content (i.e., digital meeting items) with those speakers. In particular, the speaker attribution system can analyze speaking volumes captured within audio associated with a meeting to attribute segments of the audio to meeting attendees (i.e., identify one of the meeting attendees as the speaker of one or more audio segments). For example, the audio of a meeting can include speech from a plurality of meeting attendees, where the speech of each meeting attendee corresponds to a particular speaking volume. In one or more embodiments, the speaker attribution system receives the audio from a plurality of client devices and determines the speaking volume corresponding to each meeting attendee by identifying the loudest speaking volume captured by the client device associated with that meeting attendee. In this way, the speaker attribution system can map speakers to meeting attendees and subsequently associate meeting items with the appropriate meeting attendee.

To provide an example, in one or more embodiments, the speaker attribution system can receive audio data, containing audio content of a meeting, from a plurality of client devices. The speaker attribution system can determine a primary speaking volume (e.g., a highest or loudest speaking volume) detected by a given client device by analyzing the audio data. The speaker attribution system can then associate the user (i.e., meeting attendee) of the client device with a segment of the audio content based on the primary speaking volume determined for that client device. Subsequently, the system can generate a digital meeting item (e.g., an action item) based on a transcript of the segment of the audio content and associate the meeting item with the user of the client device (e.g., send a reminder of the action item to the user) based on the association between the user and the segment of the audio content.

As just mentioned, in one or more embodiments, the speaker attribution system analyzes audio data to determine a primary speaking volume detected (i.e., captured) by a client device. For example, a client device can detect a plurality of speaking volumes, where each speaking volume corresponds to a different user associated with the meeting (i.e., a different meeting attendee). The speaker attribution system can compare the plurality of speaking volumes detected by the client device to identify the primary speaking volume for that client device.

In some embodiments, the speaker attribution system identifies the highest (i.e., loudest) speaking volume as the primary speaking volume. Specifically, in some embodiments, the speaking volume corresponding to a given user is related to the distance of that user from the client device detecting the speaking volume. Accordingly, by determining the highest speaking volume detected by a client device, the speaker attribution system can determine which speech originated from the user closest to the client device (i.e., the user associated with that client device).

As an illustration, in one or more embodiments, the speaker attribution system receives audio data from a plurality of client devices, where each client device detects a plurality of speaking volumes corresponding to the plurality of users attending the meeting. The speaker attribution system can analyze the audio data received from each client device to determine a primary speaking volume associated with that client device. The speaker attribution system can then determine that the primary speaking volume of each client device corresponds to the user of that client device.

Additionally, as mentioned above, the speaker attribution system associates segments of the audio content with a user of a client device based on the primary speaking volume determined for that client device. In particular, the speaker attribution system can identify one or more segments of the audio content that include speech corresponding to the primary speaking volume of a client device. The speaker attribution system then associates those identified segments with the user of the client device. By associating segments of the audio content with users in this way, the speaker attribution system can attribute each segment of the audio content with the appropriate speaker.

As further mentioned above, the speaker attribution system associates digital meeting items with the user of a client device based on associating segments of the audio content with that user. In particular, the speaker attribution system can generate a digital meeting item based on a segment of the audio content (e.g., a transcript of the segment of the audio content). The speaker attribution system can then associate the digital meeting item with the user to whom the segment of the audio content has been attributed. As an example, the speaker attribution system can generate an action item based on a segment of the audio content that includes a description and assignment of an action item. The speaker attribution system can subsequently associate the action item with the user to whom the segment of the audio content has been attributed (e.g., by providing a notification of the action item to the client device of the user).

The speaker attribution system provides several advantages over conventional systems. For example, the speaker attribution system operates more efficiently than conventional systems. In particular, by associating users with segments of audio content based on a primary speaking volume detected by their respective client devices, the speaker attribution system avoids using the computationally expensive models employed by conventional systems. Specifically, the speaker attribution system avoids the process required to train these models to identify the vocal characteristics or attributes that make up the voiceprint of a particular user. Consequently, the speaker attribution system reduces the amount of time, processing power, and memory required for operation.

Further, the speaker attribution system operates more flexibly than conventional systems. Specifically, by attributing segments of audio content to users using speaking volumes rather than models that detect voiceprints, the speaker attribution system can properly identify speakers without relying on previously stored voiceprint data. This allows the speaker attribution system to flexibly identify a user as the speaker of one or more segments of the audio content even if that user has not previously submitted voiceprint data (e.g., the user is a first-time user of the speaker attribution system).

Additionally, the speaker attribution system improves accuracy. For example, because the speaker attribution system can identify a user as a speaker even if the user has not previously submitted voice data, the speaker attribution system can more accurately associate segments of the audio content with users where one or more users associated with a meeting are first-time users of the system. Consequently, the speaker attribution system can accurately associate digital meeting items with the correct users.

As illustrated by the foregoing discussion, the present disclosure utilizes a variety of terms to describe features and benefits of the speaker attribution system. Additional detail is now provided regarding the meaning of these terms. For example, as used herein, the term “meeting” refers to an incident, episode, or occurrence involving one or more users (i.e., meeting attendees). In particular, a meeting refers to an assembly or gathering of multiple users associated with the meeting. For example, a meeting can include an in-person meeting, a conference call, a video call, a presentation, a job interview, a birthday party, or a doctor's appointment. In some embodiments, one or more users associated with the meeting have a client device present at the meeting.

Additionally, as used herein, the term “audio data” refers to digital data associated with noise or sound. In particular, audio data can refer to digital data representing a characteristic or attribute of sound that can be generated, detected, stored, or utilized by a computing device. For example, audio data can include audio content, frequency data, timbre data, or volume data (such as a time-based record of volume), which will be discussed in more detail below.

As used herein, the term “audio content” refers to audio data containing speech. More specifically, audio content can refer to digital data representing words (or discernible noises) generally understood by humans as spoken communication. For example, audio content can include digital data representing words (or noises) vocalized by a user (i.e., a human), presented via a communications device, presented via audio recording, or generated and presented by a machine. In one or more embodiments, audio content further includes other data associated with the speech, such as volume data. In some embodiments, however, audio content strictly refers to the content of the speech.

Relatedly, as used herein, the term “video data” refers to digital data associated with a video recording. In particular, video data can refer to digital data representing a characteristic or attribute of a visual reproduction that can be generated, detected, stored, or utilized by a computing device. Specifically, video data can include video content. As used herein, the term “video content” can refer to digital data representing the content of a video recording as opposed to other related data (e.g., frame rate data, resolution data, time data, etc.).

Further, as used herein, the term “speaking volume” refers to a loudness of speech. In particular, speaking volume can refer to how loudly a user projects speech (or discernable noises). In some embodiments, the speaking volume refers to the loudness of the speech as detected by a computing device, such as the amplitude of the corresponding audio signal received by the computing device. As such, two computing devices may attribute different speaking volumes to the same speech based on their different distances from the source of the speech. As used herein, a “primary speaking volume” refers to a highest or loudest speaking volume (i.e., a speaking volume having the largest amplitude) as detected by a client device.

Additionally, as used herein, the term “transcript” refers to a textual representation of speech. In particular, a transcript can refer to text corresponding to audio content, where the text has been generated by a human or machine transcribing the audio content. For example, a transcript can include text corresponding to a segment of the audio content or an entire meeting associated with the audio content (referred to as a “meeting transcript”).

As used herein, the term “digital meeting item” or “meeting item” refers to digital content associated with a meeting. In particular, a digital meeting item can refer to digital content that has been generated based on, or in response to, the contents of a meeting (e.g., the discussion of a meeting). For example, a digital meeting item can include a transcript of audio content associated with a meeting or portion thereof, an action item, a message, a notification, a suggested action, or a calendar item.

As used herein, the term “action item” refers to a task or operation that is assigned to a user in connection with a meeting. For example, an action item can include a task discussed during a meeting for completion by a user after the meeting is complete. In some embodiments, an action item can be associated with one or more specific users. An action item can also be associated with a date or time, by which completion of the action item is required.

United States Provisional Application titled GENERATING IMPROVED DIGITAL TRANSCRIPTS UTILIZING DIGITAL TRANSCRIPTION MODELS THAT ANALYZE DYNAMIC MEETING CONTEXTS, filed Jun. 24, 2019, and United States Provisional Application titled GENERATING CUSTOMIZED MEETING INSIGHTS BASED ON USER INTERACTIONS AND MEETING MEDIA, filed Jun. 24, 2019, are each hereby incorporated by reference in their entireties.

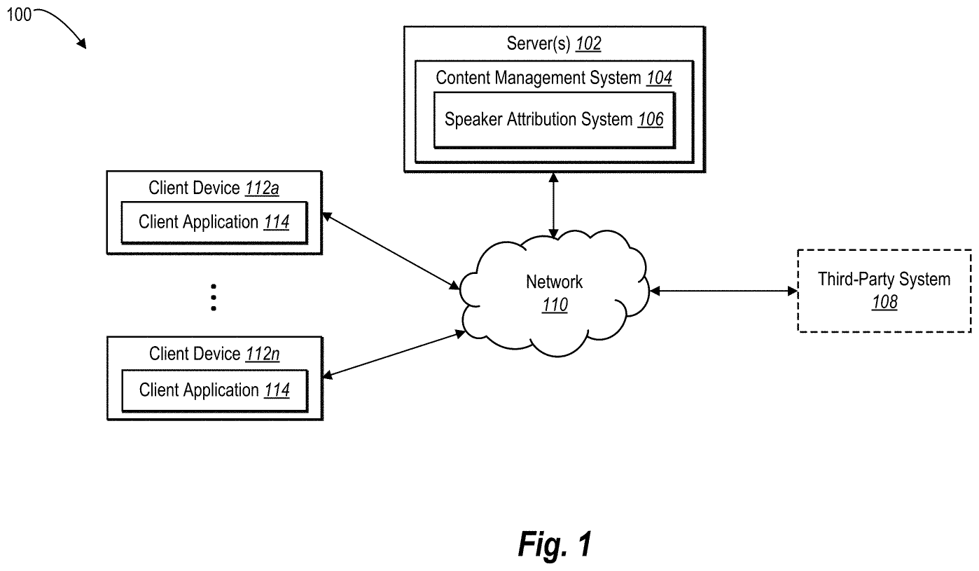

Additional detail regarding the speaker attribution system will now be provided with reference to the figures. For example, FIG. 1 illustrates a schematic diagram of exemplary system environment (“environment”) 100 in which speaker attribution system 106 can be implemented. As illustrated in FIG. 1, environment 100 can include server(s) 102, third-party system 108, and client devices 112a-112n.

Although environment 100 of FIG. 1 is depicted as having a particular number of components, environment 100 can have any number of additional or alternative components (e.g., any number of servers, third-party systems, client devices, or other components in communication with speaker attribution system 106 via network 110). Similarly, although FIG. 1 illustrates a particular arrangement of server(s) 102, third-party system 108, network 110, and client devices 112a-112n, various additional arrangements are possible.

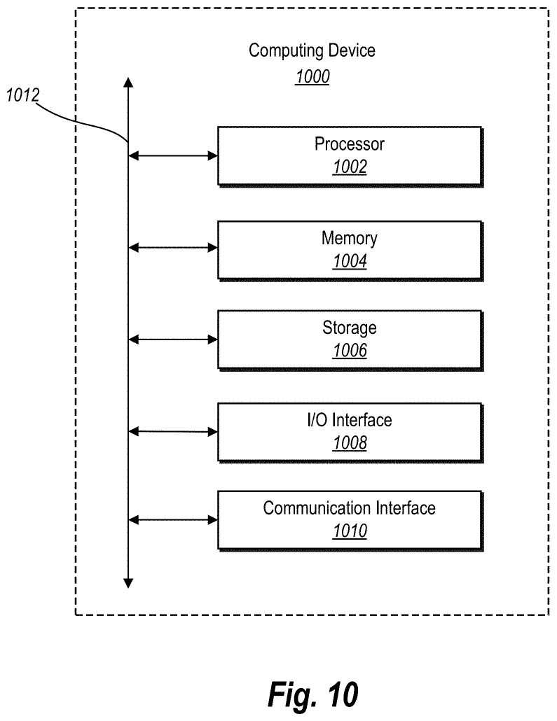

Server(s) 102, third-party system 108, network 110, and client devices 112a-112n may be communicatively coupled with each other either directly or indirectly (e.g., through network 110 discussed in greater detail below in relation to FIG. 10). Moreover, server(s) 102, third-party system 108, and client devices 112a-112n may include a computing device (including one or more computing devices as discussed in greater detail below with relation to FIG. 10).

As mentioned above, environment 100 includes server(s) 102. Server(s) 102 can generate, store, receive, and/or transmit data, including audio data, video data, and digital meeting items. For example, server(s) 102 can receive audio data that includes audio content associated with a meeting from client devices 112a-112n. Server(s) 102 can subsequently transmit a digital meeting item to one or more of client devices 112a-112n. In one or more embodiments, server(s) 102 includes a data server. Server(s) 102 can also include a communication server or a web-hosting server.

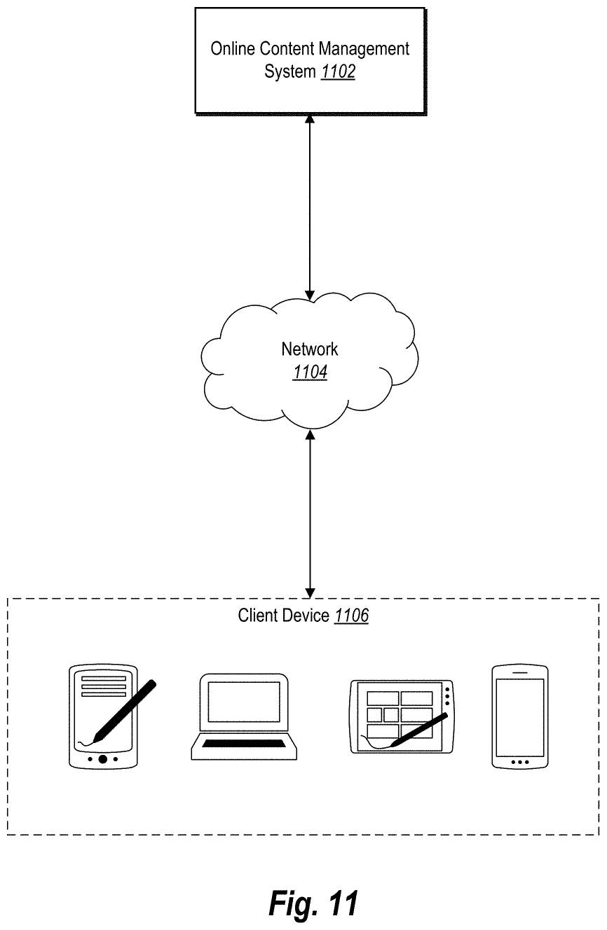

As shown in FIG. 1, server(s) 102 can include content management system 104. Broadly, content management system 104 provides functionality by which a user can generate, manage, and/or store digital content. For example, a user can generate a new digital document using client device 112a. Subsequently, the user can use client device 112a to send the digital document to content management system 104 hosted on server(s) 102 via network 110. Content management system 104 can then provide many options that the user may use to store the digital document, organize the digital document into a folder, and subsequently search for, access, and view the digital document. As a more specific example, third-party system 108 can generate a transcript of one or more segments of audio content associated with a meeting and send the transcript to content management system 104, which provides one or more users with the aforementioned options. Additional detail regarding content management system 104 is provided below (e.g., in relation to FIG. 11 and online content management system 1102).

Additionally, server(s) 102 include speaker attribution system 106. In particular, in one or more embodiments, speaker attribution system 106 uses server(s) 102 to implement volume-based speaker attribution to associate digital meeting items with users. For example, speaker attribution system 106 can use server(s) 102 to associate segments of audio content with users based on a primary speaking volume detected by a client device associated with each user and then associate digital meeting items with a particular user based on which segments of the audio content are associated with the user.

For example, in one or more embodiments, server(s) 102 can receive audio data from a plurality of client devices (e.g., client devices 112a-112n), where the audio data includes audio content associated with a meeting. Server(s) 102 can analyze the audio data to determine a primary speaking volume associated with each client device. Server(s) 102 can then associate the user of each client device with one or more segments of the audio content based on the primary speaking volume associated with that client device. Subsequently, server(s) 102 can generate meeting items related to the meeting and associate the meeting items with the users based on the segments of the audio content associated with each user.

In one or more embodiments, client devices 112a-112n include computer devices that allow users of the devices to collect audio data and receive digital meeting items. For example, client devices 112a-112n can include smartphones, tablets, desktop computers, laptop computers, or other electronic devices. Client devices 112a-112n can include one or more applications (e.g., client application 114) that allow the users to collect audio data and receive digital meeting items. For example, client application 114 can include a software application installed on client devices 112a-112n. Additionally, or alternatively, client application 114 can include a software application hosted on server(s) 102, which may be accessed by client devices 112a-112n through another application, such as a web browser.

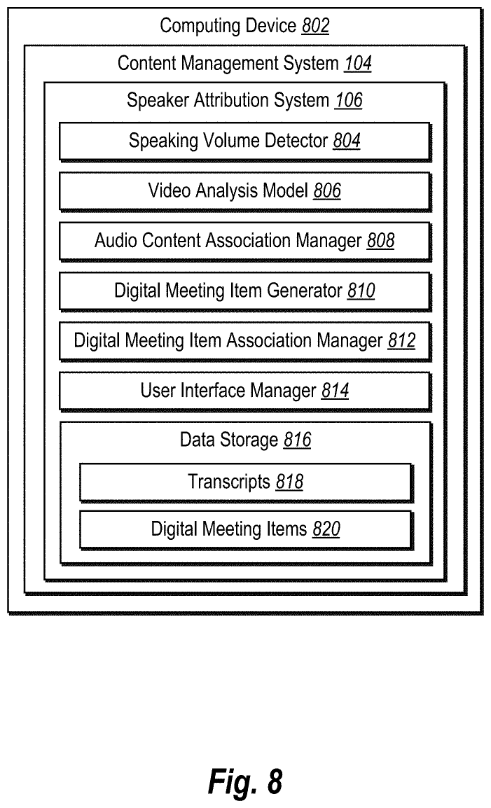

Speaker attribution system 106 can be implemented in whole, or in part, by the individual elements of environment 100. Specifically, although FIG. 1 illustrates speaker attribution system 106 implemented with regards to server(s) 102, different components of speaker attribution system 106 can be implemented in any of the components of environment 100. The components of speaker attribution system 106 will be discussed in more detail with regard to FIG. 8 below.

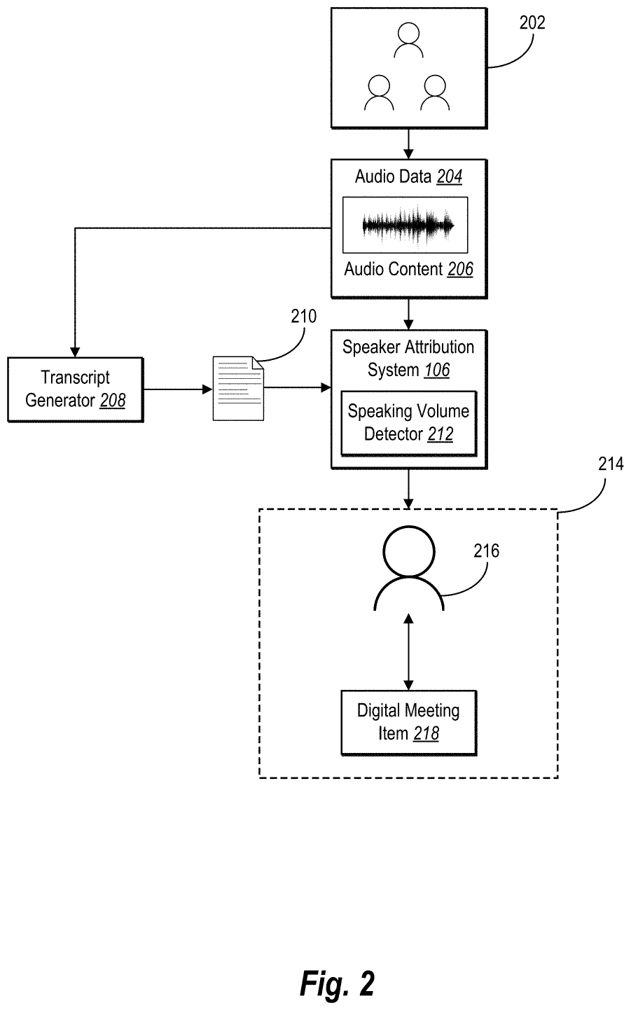

As mentioned above, speaker attribution system 106 can associate digital meeting items with users. In particular, the speaker attribution system 106 associates digital meeting items with users based on detecting a primary speaking volume associated with a client device of the user. FIG. 2 illustrates a block diagram of the speaker attribution system 106 associating digital meeting items with a user in accordance with one or more embodiments.

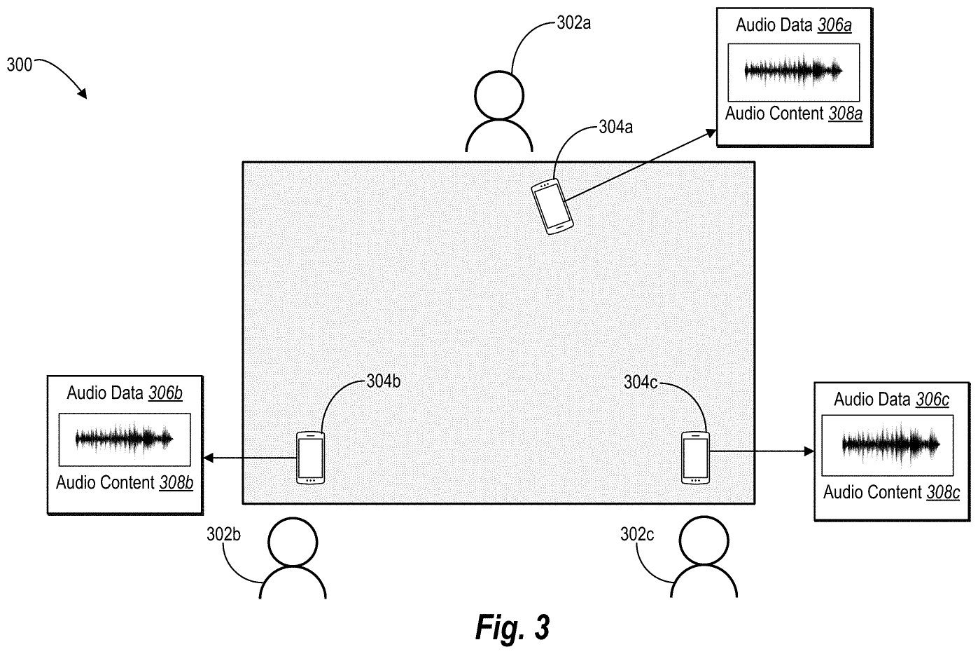

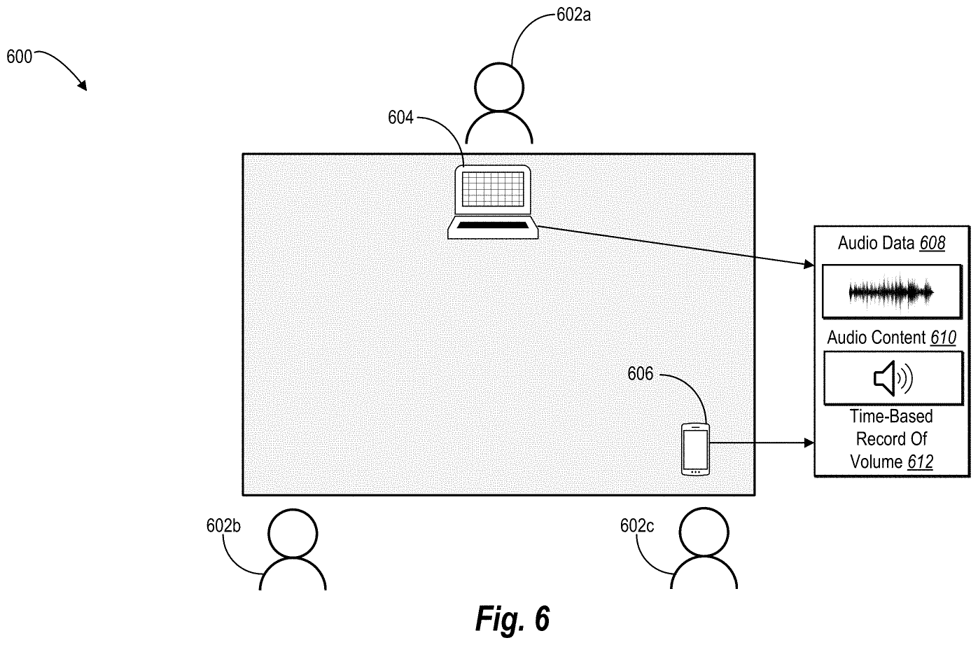

As illustrated in FIG. 2, speaker attribution system 106 can receive audio data 204 that includes audio content 206 associated with meeting 202. In particular, as shown in FIG. 2, meeting 202 including a plurality of users. In one or more embodiments, one or more of the users attending meeting 202 uses a client device to capture a set of audio data that makes up part of audio data 204, as will be discussed more below with respect to FIG. 3. In some embodiments, the plurality of users utilize one client device to capture audio content 206 and another client device to capture volume data (not shown) as will be discussed in more detail below with reference to FIG. 6.

As shown in FIG. 2, transcript generator 208 also receives audio data 204. In particular, transcript generator 208 analyzes audio data 204 to generate transcript 210. For example, in one or more embodiments, transcript generator 208 utilizes a machine learning model, such as a speech-to-text model or a natural language processing model, to process audio content 206 of audio data 204 and generate transcript 210. As illustrated by FIG. 2, transcript generator 208 is a third-party system (corresponding to third-party system 108 of FIG. 1). However, in some embodiments, transcript generator 208 a component of speaker attribution system 106.

In one or more embodiments, transcript 210 includes a textual representation of one or more segments of audio content 206. In other words, transcript generator 208 can receive one or more segments of audio content 206 and generate transcript 210 based on the received segments. In some embodiments, transcript 210 includes a textual representation of audio content 206 in its entirety.

As shown in FIG. 2, speaker attribution system 106 receives transcript 210 from transcript generator 208. Speaker attribution system 106 can then use audio data 204 and transcript 210 to determine association 214 between user 216 and digital meeting item 218. In particular, speaker attribution system 106 utilizes speaking volume detector 212 in determining association 214, as will be discussed in more detail below with regard to the subsequent figures. In one or more embodiments, user 216 is one of the plurality of users attending meeting 202. In particular, user 216 can include a user that spoke during meeting 202, the spoken words being captured as part of audio content 206. Thus, speaker attribution system 106 can use the volume projected by user 216 as user 216 speaks in order to associate digital meeting item 218 with user 216.

As discussed above, in one or more embodiments, speaker attribution system 106 can associate digital meeting items with one or more users associated with (i.e., attending) a meeting. In particular, speaker attribution system 106 can utilize audio data having audio content associated with the meeting in order to associate digital meeting items with one or more of the users. FIG. 3 illustrates meeting environment 300 in which users 302a-302c attend a meeting and capture audio data associated with the meeting in accordance with one or more embodiments.

As shown in FIG. 3, users 302a-302c are associated with client devices 304a-304c, respectively. Users 302a-302c can utilize client devices 304a-304c to generate an audio recording of the meeting. In particular, client devices 304a-304c can capture audio data 306a-306c, respectively. In other words, each user of a meeting can use a client device to capture audio data of a meeting, which speaker attribution system 106 then uses to associate digital meeting items with the users (i.e., each of audio data 306a-306c can include a separate set of audio data that combines to form audio data 204 of FIG. 2). In some embodiments, however, only a fraction of the users attending a meeting use a client device to capture audio data of the meeting. For example, in some embodiments, only the users who will be participating in the meeting (i.e., speaking during the meeting) capture audio data while those users not participating in the meeting (i.e., spectators) do not capture any audio data.

Further, as illustrated by FIG. 3, audio data 306a-306c includes audio content 308a-308c, respectively, associated with the meeting. In one or more embodiments, audio content 308a-308c are duplicates in that each of audio content 308a, 308b, and 308c includes the same speech from users 302a-302c. In some embodiments, however, one or more of audio content 308a-308c is different, including one or more segments of audio not captured by one or more of client devices 304a-304c. To provide an example, the distance between user 302a and client device 304b can be great enough such that client device 304b does not capture one or more words or phrases spoken by user 302a (e.g., user 302a speaks so softly that client device 304b cannot detect the sound). Client device 304a, however, may be close enough to capture that speech. Consequently, audio content 308a can include the speech of user 302a, and audio content 308b may omit that speech.

In one or more embodiments, because users 302a-302c are each positioned at a different distance from each of client devices 304a-304c, each of audio content 308a-308c will include a different speaking volume corresponding to each of users 302a-302c. For example, audio content 308a can include a first speaking volume corresponding to user 302a, a second speaking volume corresponding to user 302b, and a third speaking volume corresponding to user 302c. Because user 302a is closer to client device 304a than user 302b and user 302c, the first speaking volume corresponding to user 302a can be higher (i.e., louder) than the second speaking volume and the third speaking volume. Meanwhile, audio content 308b can include a speaking volume corresponding to user 302b that is higher than the speaking volumes that correspond to user 302a or user 302c. Likewise, audio content 308c can include a speaking volume corresponding to user 302c that is higher than the speaking volumes that correspond to user 302a and user 302b.

As mentioned above, a transcript generator (either a third-party service or a component of speaker attribution system 106) can utilize audio data 306a-306c to generate a transcript of one or more segments of audio content 308a-308c. In terms of speaker attribution system 106 implementing the transcript generator, in one or more embodiments, speaker attribution system 106 can generate the transcript using the audio content having the highest quality. For example, if client device 304b and client device 304c each have a lower quality microphone than client device 304a, speaker attribution system 106 can determine to utilize audio data 306a in generating the transcript. In other embodiments, however, speaker attribution system 106 can generate a separate transcript using each of audio data 306a-306c and then combine the transcripts to generate a finalized transcript. For example, speaker attribution system 106 can assign a weight to each transcript based on a determined quality of the transcript or an identified quality of the microphone used to capture the corresponding audio. Speaker attribution system 106 can then combine the weighted transcripts to generate the finalized transcript.

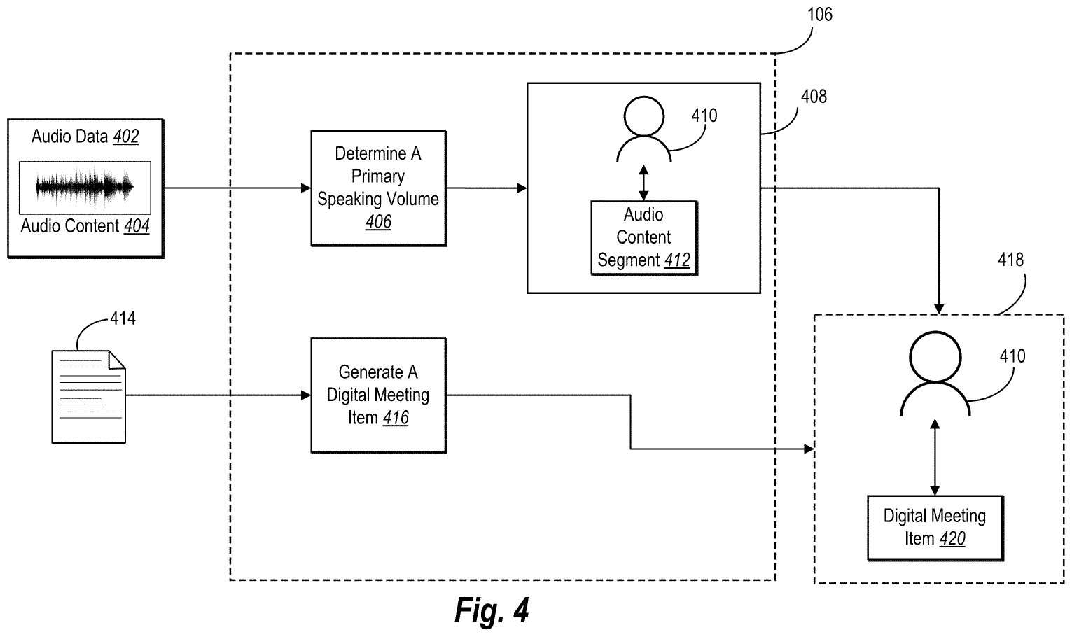

As discussed, speaker attribution system 106 utilizes audio data having audio content associated with a meeting to associate digital meeting items with users associated with the meeting. In particular, in one or more embodiments, speaker attribution system 106 receives audio data from a plurality of client devices. Speaker attribution system 106 can analyze the audio data received from each client device to associate the user of that device with one or more digital meeting items. FIG. 4 illustrates a block diagram for associating a digital meeting item with a user in accordance with one or more embodiments.

As shown in FIG. 4, speaker attribution system 106 receives audio data 402, which includes audio content 404 associated with a meeting. Specifically, speaker attribution system 106 receives audio data 402 from the client device of a user attending the meeting. As an example, audio data 402 can correspond to one of audio data 306a-306c received from one of client devices 304a-304c of FIG. 3.

Speaker attribution system 106 analyzes audio data 402 to determine a primary speaking volume 406 associated with the client device from which audio data 402 was received. In one or more embodiments, audio data 402 includes data corresponding to a plurality of speaking volumes detected by the client device. Each speaking volume can correspond to a different user that attended the meeting, and the speaking volumes can differ based on the distance between the corresponding users and the client device collecting audio data 402. Speaker attribution system 106 can analyze audio data 402 to determine a primary speaking volume 406 by comparing the plurality of speaking volumes and identifying a highest (i.e., loudest) speaking volume as the primary speaking volume. Specifically, speaker attribution system 106 can determine that the loudest speaking volume was provided by the user positioned closest to the client device collecting audio data 402, and therefore the user associated with the client device.

As shown in FIG. 4, speaker attribution system 106 can then generate association 408 between user 410 and audio content segment 412. Specifically, user 410 can include the user of the client device that collected audio data 402. And audio content segment 412 can include a segment of audio content 404 that includes speech corresponding to the primary speaking volume determined for that client device. Accordingly, speaker attribution system 106 associates user 410 with audio content segment 412 (i.e., attributes audio content segment 412 to user 410) based on determining that user 410 provided the speech included in audio content 404.

In one or more embodiments, speaker attribution system 106 associates user 410 with audio content segment 412 further based on an authentication received from the client device of user 410. In particular, the client device of user 410 (i.e., the same client device used to collect audio data 402) can include a computer application installed on, or otherwise accessed through, the client device. In one or more embodiments, the computer application is the same application employed by the client device to collect audio data 402. User 410 can log into the computer application through the client device using one or more login credentials (e.g., a username, a password, etc.) that authenticate the identity of user 410. Speaker attribution system 106 can receive the authentication from the computer application when user 410 logs in and use that authentication to determine the identity (i.e., the real-world identity) of user 410, and thus the identity of the user providing the speech included in audio content segment 412.

Further, as FIG. 4 illustrates, speaker attribution system 106 receives transcript 414 (though, as mentioned, speaker attribution system can generate transcript 414 in some embodiments). In particular, in one or more embodiments, transcript 414 includes a textual representation of audio content segment 412. Using transcript 414, speaker attribution system 106 can perform an operation to generate a digital meeting item 416. Because transcript 414 can be a textual representation of audio content segment 412, digital meeting item 420 resulting from the operation corresponds to audio content segment 412. For example, if audio content segment 412 includes speech in which a user (i.e., user 410) accepted an action item, then digital meeting item 420 can include the accepted action item.

In one or more embodiments, speaker attribution system 106 performs the operation to generate a digital meeting item 416 using natural language processing techniques. For example, speaker attribution system 106 can utilize a natural language processing model to process transcript 414 and identify words or phrases that correspond to a digital meeting item. In some embodiments, speaker attribution system 106 can apply one or more rules to transcript 414 in order to identify one or more pre-established keywords or key phrases that correspond to a digital meeting item.

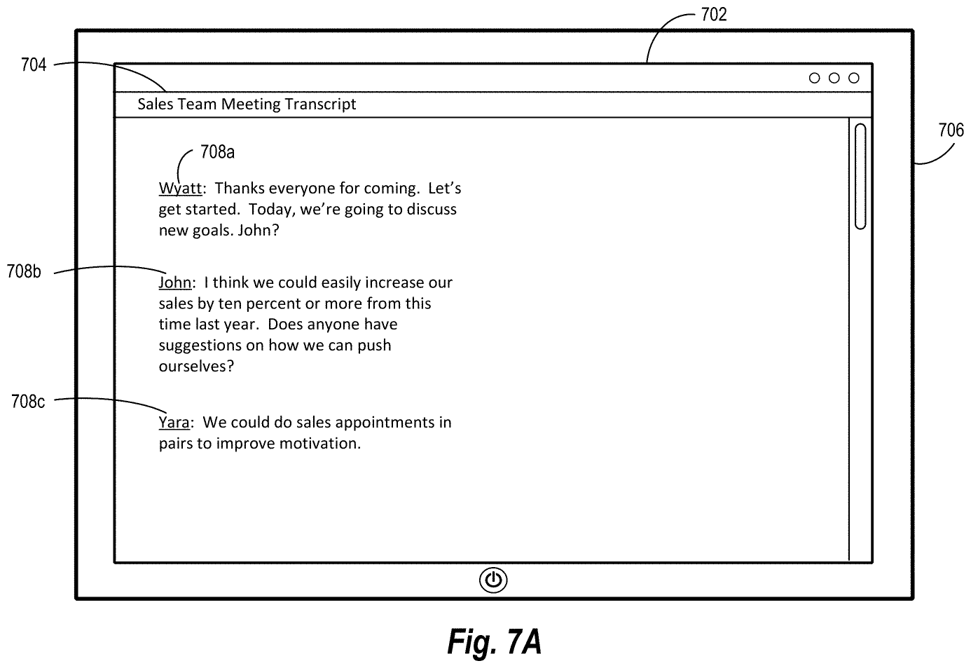

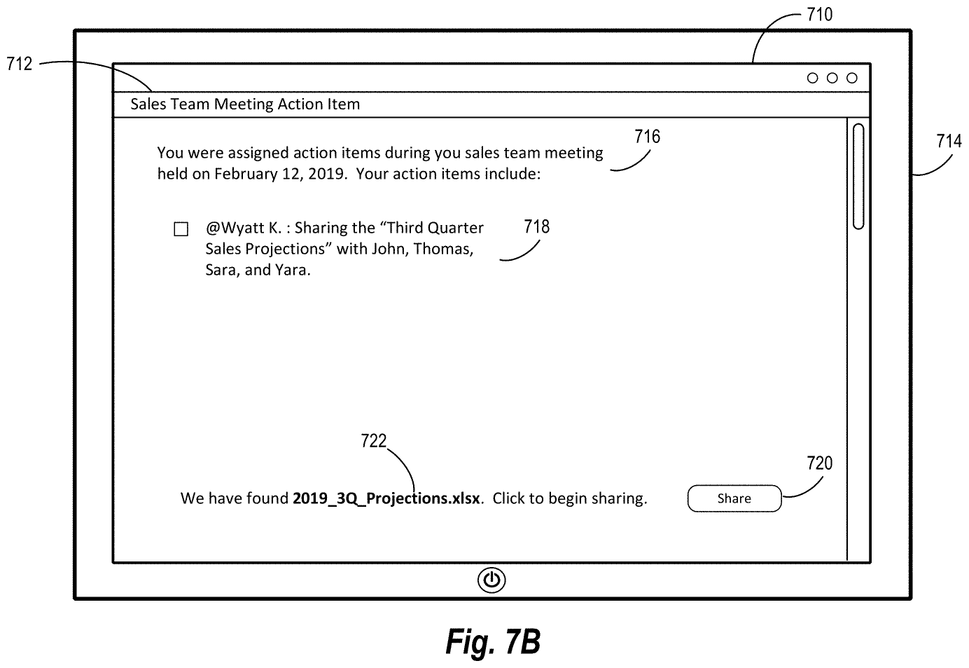

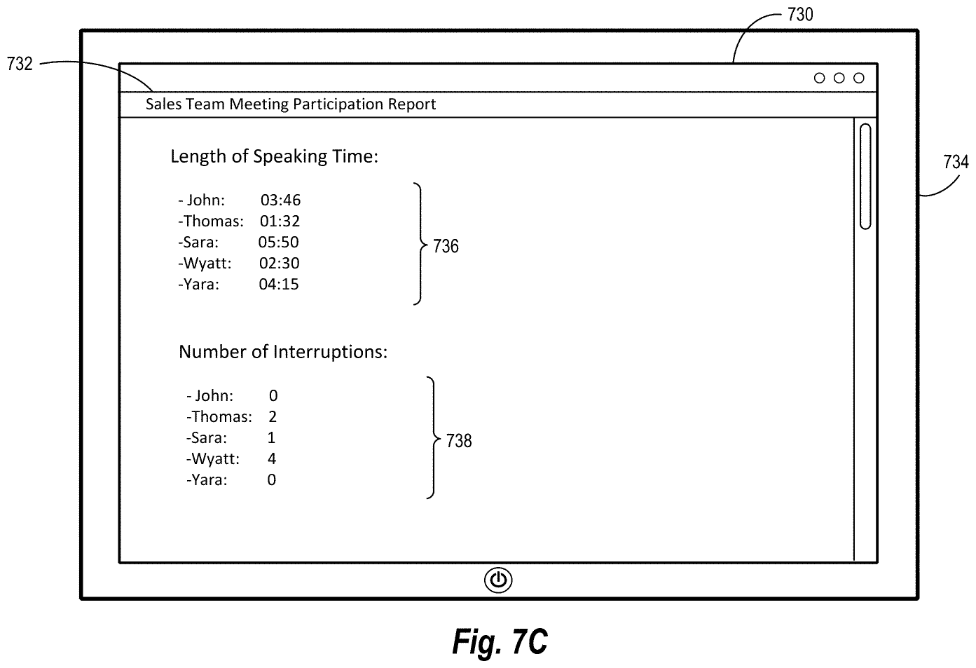

After generating digital meeting item 420 and associating user 410 with audio content segment 412 based on the determined primary speaking volume, speaker attribution system 106 generates association 418 between user 410 and digital meeting item 420. In particular, speaker attribution system 106 associates user 410 with digital meeting item 420 based on association 408 between user 410 and audio content segment 412. Associating user 410 and digital meeting item 420 can include one or more operations depending on the nature of digital meeting item 420. As a brief example, where digital meeting item 420 includes an action item, speaker attribution system 106 can associate user 410 with digital meeting item 420 by generating an action item prompt to complete the action item and providing the action item prompt for display on the client device of user 410. Associating users and action items will be discussed in more detail below with regards to FIGS. 7A-7C.

Speaker attribution system 106 can similarly receive audio data (and transcripts) from a client device of every user that attended (or at least spoke in) the meeting. Speaker attribution system 106 can analyze the received audio data to determine a primary speaking volume detected by the client devices and associate the user of each client device with the appropriate audio content segments based on the primary speaking volume corresponding to that device. Thus, by associating users with audio content segments based on a primary speaking volume detected by the client devices of those users, speaker attribution system 106 can accurately associate the users with the appropriate digital meeting items. Further, by relying on primary speaking volumes rather than models trained to recognize voiceprints, speaker attribution system 106 operates more efficiently.

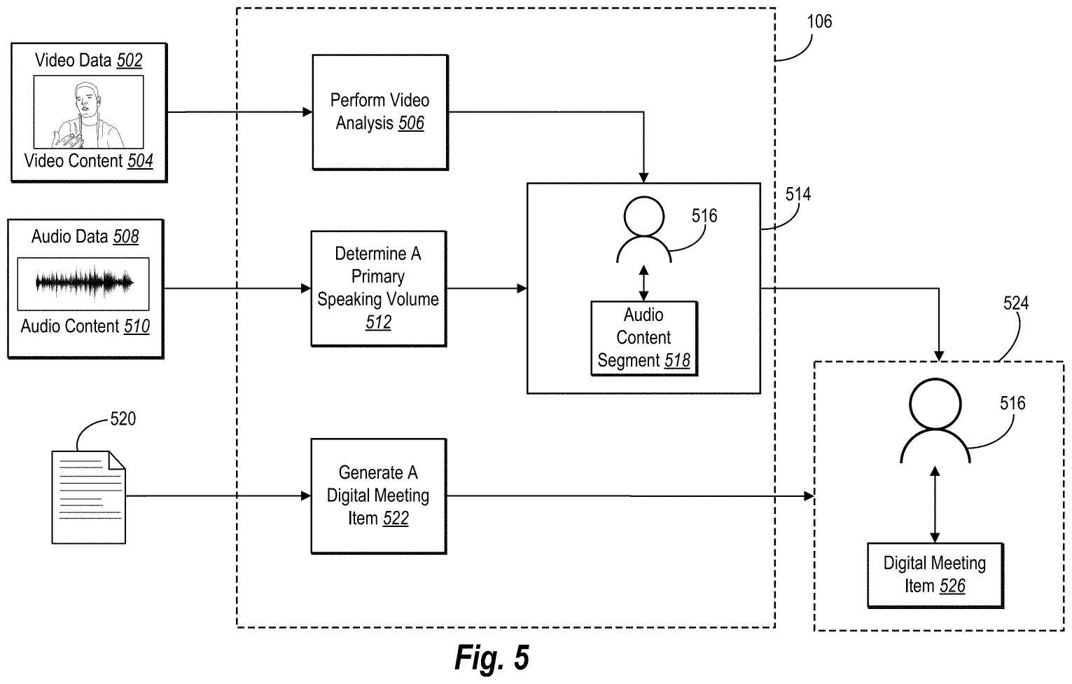

In one or more embodiments, speaker attribution system 106 utilizes video data in associating users with digital meeting items. In particular, speaker attribution system 106 can analyze video data in identifying a user as a speaker of one or more segments of audio content. FIG. 5 illustrates a block diagram for using video data to associate digital meeting items with a user in accordance with one or more embodiments. In particular, as shown in FIG. 5, speaker attribution system 106 can modify its operation as discussed with regard to FIG. 4 in order to accommodate the availability of the video data.

As shown in FIG. 5, speaker attribution system 106 can receive video data 502, which includes video content 504 associated with the meeting. In particular, video content 504 can include a video recording of the meeting. Video content 504 can be unique to each user attending the meeting or can include a video recording of the meeting as a whole (e.g., a wide-angle shot of the meeting environment, recording all users attending the meeting simultaneously). In some embodiments, video data 502 includes additional video-related data utilized by speaker attribution system 106. For example, video data 502 can further include a time record that speaker attribution system 106 can use to map segments of video content 504 with segments of audio content 510.

Speaker attribution system 106 can perform video analysis 506 on video data 502 to identify which user is speaking during a particular segment of video content 504. In one or more embodiments, speaker attribution system 106 identifies speakers by analyzing video content 504 to detect lip movement. In some embodiments, speaker attribution system 106 analyzes video content 504 to detect other user movement, such as standing, gesturing, walking, or writing on a whiteboard.

As shown in FIG. 5, speaker attribution system 106 can utilize the analysis of video data 502 to generate association 514 between user 516 and audio content segment 518. In particular, speaker attribution system 106 can generate association 514 based on the analysis of video data 502 and the analysis of audio data 508. For example, by identifying the primary speaking volume associated with the client device through which audio data 508 was received, speaker attribution system 106 can identify user 516 as the user whose speech is recorded in audio content segment 518. By analyzing video data 502, speaker attribution system 106 can confirm (or, in some cases, contradict) the identification of user 516 as the speaker. In one or more embodiments, video data 502 and audio data 508 includes a time-based record usable by speaker attribution system 106 to synchronize video content 504 and audio content 510, thereby mapping segments of video content 504 to segments of audio content 510.

To provide an example, as discussed above with reference to FIG. 4, speaker attribution system 106 can receive audio data 508 having audio content 510 associated with the meeting. Further, speaker attribution system 106 can analyze audio data 508 to determine a primary speaking volume 512 associated with the client device from which audio data 508 was received. Speaker attribution system 106 can use the determined primary speaking volume to generate a confidence score (e.g., an audio component of a confidence score) related to identification of user 516 as the speaker. Speaker attribution system 106 can then use the analysis of video data 502 to modify the confidence score (e.g., add a video component to the audio component to generate a combined confidence score).

Based on the modified confidence score, speaker attribution system 106 can associate user 516 with audio content segment 518. For example, in one or more embodiments, speaker attribution system 106 can associate user 516 with audio content segment 518 based on determining that the modified confidence score satisfies a confidence score threshold. In some embodiments, speaker attribution system 106 generates a confidence score for several of the users attending the meeting and associates audio content segment 518 with the user corresponding to the highest confidence score. Thus, utilizing video data 502 can improve the accuracy by which speaker attribution system 106 attributes segments of audio content 510 to users.

In one or more embodiments, speaker attribution system 106 can further perform video analysis 506 on video data 502 by implementing facial recognition. For example, speaker attribution system 106 can process video data 502 using a facial recognition model to determine the identity (i.e., the real-world identity) of user 516, and thus the identity of the user providing the speech included in audio content segment 518. Speaker attribution system 106 can utilize any available (e.g., third-party) facial recognition technology as the facial recognition model. In one or more embodiments, speaker attribution system 106 uses the facial recognition in conjunction with receiving an authentication received from the client device of user 516 to determine the identity of user 516.

Further, as discussed above, speaker attribution system 106 can perform an operation to generate a digital meeting item 522 based on transcript 520. Speaker attribution system 106 can then generate association 524 between user 516 and digital meeting item 526 based on associating user 516 with audio content segment 518. Thus, utilizing video data 502 can also improve the accuracy by which speaker attribution system 106 associates users and digital meeting items.

In one or more embodiments, the plurality of users attending a meeting utilize two client devices to collect separate audio data components (rather than each user utilizing a corresponding client device to collect audio data, as discussed in FIG. 3). FIG. 6 illustrates meeting environment 600 in which users 602a-602c attend a meeting and capture audio content and volume data using separate client devices, in accordance with one or more embodiments.

As shown in FIG. 6, users 602a-602c utilize client device 604 and client device 606 to collect different components of audio data 608. In particular, client device 604 records audio content 610 associated with the meeting, and client device 606 collects volume data. As shown in FIG. 6, client device 606 can use the collected volume data to generate time-based record of volume 612. Time-based record of volume 612 can include data points indicating a level of volume at every point in time in the meeting. Speaker attribution system 106 can use time-based record of volume 612 to synchronize the included volume levels with audio content 610 collected by client device 604.

In one or more embodiments, each volume level (or each volume level within a particular volume range) reflected within time-based record of volume 612 corresponds to one of users 602a-602c. Speaker attribution system 106 can, therefore, associate users 602a-602c with segments of audio content 610 based on the volume level associated with each segment of audio content 610. For example, user 602c is positioned closest to client device 606. Speaker attribution system 106 can, therefore, associate the highest volume level (or highest volume range) with user 602c. Consequently, speaker attribution system 106 can associate the segments of audio content 610 corresponding to the highest volume levels with user 602c.

After receiving audio data 608, speaker attribution system 106 can operate to associate at least one of users 602a-602c with one or more digital meeting items generated based on segments of audio content 610. In one or more embodiments, speaker attribution system 106 operates as discussed above with reference to FIGS. 4-5 to associate users 602a-602c and digital meeting items with the notable difference that speaker attribution system 106 utilizes time-based record of volume 612 in associating users 602a-602c with segments of audio content 610. In one or more embodiments, speaker attribution system 106 receives input, in addition to audio data 608, in order to determine the identity (i.e., the real-world identity) of each of users 602a-602c. For example, in some embodiments, speaker attribution system 106 can receive video data and perform video analysis (e.g., facial recognition) as discussed above with regard to FIG. 5 to determine an identity of each of users 602a-602c. In other embodiments, speaker attribution system 106 can receive input from at least one of users 602a-602c that provides the identities of users 602a-602c.

In one or more embodiments, meeting environment 300 includes an omnidirectional microphone (not shown) that captures audio data. Indeed, the omnidirectional microphone can determine a directionality of incoming audio data (e.g., from which direction speech originates). Speaker attribution system 106 can utilize this determination of directionality to assign speech originating from a particular direction to a given user (e.g., assign all speech originating from the same direction to the same user).

In some embodiments, speaker attribution system 106 performs speaker attribution using a conference bridge line. For example, the meeting environment can include a conference bridge that allows the participation of one or more users who are not physically present within the meeting environment. Further, a meeting may take place wholly outside of a physical meeting environment (e.g., all participants are connected via the conference bridge line). Speaker attribution system 106 can attribute speech to a given user based on the phone line from which the speech originates. Indeed, speaker attribution system 106 can determine a phone number from which a user is dialing in and attribute the speech originating from that phone number to the associated user.

In some embodiments, speaker attribution system 106 combines a volume-based approach with voiceprint data and/or inflection data to perform speaker separation and identification. For example, in one or more embodiments, speaker attribution system 106 generates a digital key of various inputs to identify when a particular user is speaking. The inputs used by speaker attribution system 106 can include audio data and video data. In some embodiments, speaker attribution system 106 builds a profile regarding how a particular user speaks (e.g., words used, inflections, mannerisms, etc.), how the user moves when speaking (e.g., body posture, gestures, etc.) and/or other sensor inputs, such as heart rate increase when the user speaks or breathing patterns. Speaker attribution system 106 can include one or more elements of such a profile as inputs into the digital key and then utilize the key when performing speaker separation and identification. Using such digital keys provides improved speaker attribution, especially where one or more users are not associated with a nearby client device and/or multiple users are proximate to one client device gathering audio data.

As mentioned above, speaker attribution system 106 can generate digital meeting items based on transcripts of audio content segments. Speaker attribution system 106 can then associate digital meeting items with users in one of several ways depending on the nature of the digital meeting item. FIGS. 7A-7C each illustrate associating a digital meeting item with one or more users in accordance with one or more embodiments. In particular, FIGS. 7A-7C illustrate providing a digital meeting item associated with a user to a client device associated with the user.

FIG. 7A illustrates user interface 702 displaying meeting transcript 704 for viewing on client device 706. In particular, in one or more embodiments, speaker attribution system 106 generates a digital meeting item by generating meeting transcript 704. For example, speaker attribution system 106 can combine the transcripts of every segment of audio content associated with a meeting to generate meeting transcript 704.

As shown in FIG. 7A, speaker attribution system 106 can associate meeting transcript 704 with a user by modifying meeting transcript 704 to include identification tag 708a corresponding to the user. In other words, meeting transcript 704 can initially include default identifiers (e.g., “speaker 1,” “speaker 2,” etc.) that separates the text within meeting transcript 704 by user. Speaker attribution system can then generate identification tag 708a indicating the identity (i.e., the real-world identity) of the corresponding user and modify meeting transcript 704 to include identification tag 708a. As shown in FIG. 7A, identification tag 708a can include the name of the corresponding user.

As further shown in FIG. 7A, speaker attribution system 106 can associate the same digital meeting item with multiple users. In particular, meeting transcript 704 further includes identification tag 708b and identification tag 708c corresponding to additional users that spoke during the meeting. Speaker attribution system 106 can provide meeting transcript 704 to each of the users corresponding to identification tags 708a-708c.

FIG. 7B illustrates user interface 710 displaying action item prompt 712 for viewing on client device 714. In particular, in one or more embodiments, speaker attribution system 106 generates a digital meeting item by generating an action item. Accordingly, associating the digital meeting item with a user can include generating action item prompt 712 and providing action item prompt 712 for display on a client device associated with the user (i.e., client device 714). Though action item prompt 712 of FIG. 7B corresponds to an assignment for a user to share a document with one or more other users, it should be noted that action item prompt 712 can vary depending on the nature of the action item.

As shown in FIG. 7B, action item prompt 712 can include action item basis 716 and action item 718. In particular, action item basis 716 can explain where action item 718 originated (i.e., the meeting in which action item 718 was assigned or accepted). Action item 718 includes an action item description. For example, action item 718 describes the user assigned action item 718 and the action to be taken.

In one or more embodiments, action item prompt 712 also includes action option 720. In response to a user selection of action option 720, speaker attribution system 106 can initiate performance of action item 718. For example, as shown in FIG. 7B, speaker attribution system 106 can initiate sharing of document 722 identified based on a description included within action item 718.

In general, where an action item includes an assignment for a user to share a document with one or more other users, speaker attribution system 106 can identify the document to be shared using volume-based speaker attribution. In particular, speaker attribution system 106 can identify the document based on the association between a user and the audio segment content on which the action item is based. In one or more embodiments, speaker attribution system 106 searches one or more databases storing documents to identify a document associated with the user. For example, speaker attribution system 106 can locate the document by searching for documents authored by the user or documents accessed by the user. Speaker attribution system 106 can further determine the relevance of these documents by looking at frequency and/or recency data (e.g., how recently did the user create the document or how frequently does the user access the document). In some embodiments, speaker attribution system 106 can locate the document using a description of the document provided within audio segment content. For example, speaker attribution system 106 can match terms used to describe the document with terms used in title of the document, metadata of the document, or the body of the document.

In one or more embodiments, speaker attribution system 106 searches for the document (e.g., from documents managed or stored by content management system 104) using several of the aforementioned factors, assigns a weight to each of the factors, and then generates a weighted score for each located document indicating a confidence that the document is the document referred to in the audio content segment. Speaker attribution system 106 can then provide a document within action item prompt 712 based on the weighted score. For example, speaker attribution system 106 can provide the document having the highest weighted score or the document having a weighted score that satisfies a threshold.

In one or more embodiments, speaker attribution system 106 can provide multiple documents within action item prompt 712. For example, speaker attribution system 106 can provide all documents having a weighted score that exceeds a threshold, all documents having a tied weighted score, or a number of documents having the highest weighed scores. In such embodiments, action item prompt 712 can further include a selection of the document to share.

In some embodiments, speaker attribution system 106 further provides a browse option. In response to a user selection of the browse option, speaker attribution system 106 can provide an interface through which the user can manually search for the correct document. For example, speaker attribution system 106 can provide the browse option where none of the identified documents has a weighted score that satisfies a threshold. Or speaker attribution system 106 can provide the browse option in addition to providing one or more documents within action item prompt 712. Thus, speaker attribution system 106 provide action item prompt 712 to facilitate completion of action item 718.

FIG. 7C illustrates user interface 730 displaying participation report 732 for viewing on client device 734. In particular, in one or more embodiments, speaker attribution system 106 can utilize volume-based attribution to track the participation of each user attending the meeting. Speaker attribution system 106 can generate a digital meeting item by generating participation report 732. Accordingly, associating participation report 732 with one or more users can include modifying participation report 732 to include an identification tag for each user included in participation report 732. Associating participation report 732 with one or more users can further include sending participation report 732 to a client device of each user. In some embodiments, speaker attribution system 106 can further send participation report 732 not included in participation report (e.g., a team supervisor or meeting moderator).

As shown in FIG. 7C, participation report 732 can include speaking time data 736 indicating the length of time used by each user to speak. In one or more embodiments, participation report 732 can additionally, or alternatively, include data reflecting a number of times each user spoke. As shown in FIG. 7C, participation report 732 can further include interruption data 738 indicating the number of times a user interrupted another user.

Though FIG. 7C shows participation report 732 including participation data corresponding to a plurality of users, in some embodiments, participation report 732 is individualized on a user-by-user basis. For example, speaker attribution system 106 can include only participation data corresponding to one user within participation report 732 and then send participation repot 732 to a client device of that user.

It should be noted that FIGS. 7A-7C illustrate example digital meeting items and methods of associating those digital meeting items with one or more users. Speaker attribution system 106 can generate other digital meeting items and associate digital meeting items with users using other methods. For example, speaker attribution system 106 can generate other digital, such as messages (e.g., email messages), meeting summaries, notifications, and calendar items. For example, speaker attribution system 106 can generate a meeting summary that briefly describes the contents of the meeting and associate the meeting summary with a user by sending the meeting summary to an email address associated with the user. As another example, speaker attribution system 106 can generate a calendar event, identifying the deadline of an action item and associate the calendar event with a user by adding the calendar event to a digital calendar of the user.

To provide another example, in one or more embodiments, speaker attribution system 106 can determine a correlation between an utterance of a user spoken during a meeting and an action performed on a client device of the user simultaneously (or in close temporal proximity). Specifically, speaker attribution system 106 can associate the action performed on the client device with a segment of audio content attributed to the user through volume-based speaker attribution. Speaker attribution system 106 can then generate, as a digital meeting item, a suggested action that corresponds to the action performed on the client device. Speaker attribution system 106 can then associate the action with the user by generating an action prompt suggesting the action and providing the action prompt for display on the client device the next time the user speaks the same (or a similar) utterance during a meeting. In some embodiments, speaker attribution system 106 can automatically trigger performance of the suggested action on the client device when the user speaks the utterance.

Speaker attribution system 106 can generate digital meeting items and associate the digital meeting items with users either during the meeting or after the meeting (or both), depending on the nature of the digital meeting item and/or the preferences of the users involved. For example, in some embodiments, speaker attribution system 106 can generate and provide a participation report (e.g., participation report 732) during the meeting, such as to a meeting moderator to allow the meeting moderator to better control execution of the meeting. As another example, in some embodiments, speaker attribution system 106 can provide a meeting transcript (e.g., meeting transcript 704), as modified using identification tags, to users after a meeting to allow the users to review the contents of the meeting.

Turning now to FIG. 8, additional detail will now be provided regarding various components and capabilities of speaker attribution system 106. In particular, FIG. 8 illustrates speaker attribution system 106 implemented by computing device 802 (e.g., server(s) 102 as discussed above with reference to FIG. 1). Additionally, speaker attribution system 106 is also part of content management system 104. As shown, speaker attribution system 106 can include, but is not limited to, speaking volume detector 804, video analysis model 806, audio content association manager 808, digital meeting item generator 810, digital meeting item association manager 812, user interface manager 814, and data storage 816 (which includes transcripts 818 and digital meeting items 820).

As just mentioned, and as illustrated in FIG. 8, speaker attribution system 106 includes speaking volume detector 804. In particular, speaking volume detector 804 can analyze audio data received from a plurality of client devices to determine a primary speaking volume associated with each of the client devices. For example, speaking volume detector 804 can analyze a plurality of speaking volumes associated with a first set of audio data received from a first client device to determine a primary speaking volume associated with the first client device. In one or more embodiments, speaking volume detector 804 compares the plurality of speaking volumes and identifies the highest (i.e., loudest) speaking volume as the primary speaking volume.

Further, as shown, speaker attribution system 106 includes video analysis model 806. In particular, video analysis model 806 can analyze video data to facilitate identifying a speaker in one or more segments of audio content. For example, video analysis model 806 can analyze video data to determine which user attending the meeting is speaking at any given point in time by detecting movement, such as lip movement, standing, gesturing, walking, or writing on a whiteboard. Additionally, in some embodiments, video analysis model 806 can implement a facial recognition model to process the video data and determine an identity (i.e., a real-world identity) of the user identified as a speaker.

Additionally, as shown in FIG. 8, speaker attribution system 106 includes audio content association manager 808. In particular, audio content association manager 808 can associate segments of audio content with users. More specifically, audio content association manager 808 can utilize the primary speaking volume detected for each client device by speaking volume detector 804 to associate the user of that client device with one or more segments of audio content containing speech associated with that primary speaking volume. In one or more embodiments, audio content association manager 808 can further user the analysis of video data performed by video analysis model 806 to associate users with segments of audio content.

Further, as shown, speaker attribution system 106 includes digital meeting item generator 810. In particular, digital meeting item generator 810 can generate digital meeting items based on transcripts of audio content segments. For example, if an audio content segment includes speech describing and/or assigning an action item, digital meeting item generator 810 can analyze the transcript of the audio content and generate an action item based on the included description. In one or more embodiments, digital meeting item generator 810 utilizes natural language processing techniques to analyze a transcript and identify a digital meeting item. In some embodiments, digital meeting item generator 810 applies a set of rules to a transcript in order to extract any included digital meeting items.

Additionally, as shown, speaker attribution system 106 includes digital meeting item association manager 812. In particular, digital meeting item association manager 812 can associate digital meeting items with users. For example, digital meeting item association manager 812 can receive a digital meeting item generated by digital meeting item generator 810 and associate the digital meeting item with a user. In one or more embodiments, digital meeting item association manager 812 associates the digital meeting item with a user based on the audio content segment from which the digital meeting item was generated and the association of that audio content segment with the user.

As shown above, speaker attribution system 106 further includes user interface manager 814. In particular, user interface manager 814 can manage presentation of digital meeting items on client devices. For example, user interface manager 814 can format meeting transcripts, action item prompts, messages, notifications, and calendar items.

Additionally, as shown speaker attribution system 106 includes data storage 816. In particular, data storage 816 includes transcripts 818 and digital meeting items 820. Transcripts 818 stores transcripts of audio content segments. Digital meeting item generator 810 can receive a transcript of a segment of audio content from transcripts 818 and generate a digital meeting item based on the transcript. Digital meeting items 820 includes those digital meeting items generated by digital meeting item generator 810. In some embodiments, digital meeting items 820 further includes associations between the digital meeting items and users as determined by digital meeting item association manager 812.

Each of components 804-820 of speaker attribution system 106 can include software, hardware, or both. For example, components 804-820 can include one or more instructions stored on a computer-readable storage medium and executable by processors of one or more computing devices, such as a client device or server device. When executed by the one or more processors, the computer-executable instructions of speaker attribution system 106 can cause the computing device(s) to perform the methods described herein. Alternatively, components 804-820 can include hardware, such as a special-purpose processing device to perform a certain function or group of functions. Alternatively, components 804-820 of speaker attribution system 106 can include a combination of computer-executable instructions and hardware.

Furthermore, components 804-820 of speaker attribution system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, components 804-820 of speaker attribution system 106 may be implemented as a stand-alone application, such as a desktop or mobile application. Furthermore, components 804-820 of speaker attribution system 106 may be implemented as one or more web-based applications hosted on a remote server. Alternatively, or additionally, components 804-820 of speaker attribution system 106 may be implemented in a suite of mobile device applications or “apps.”

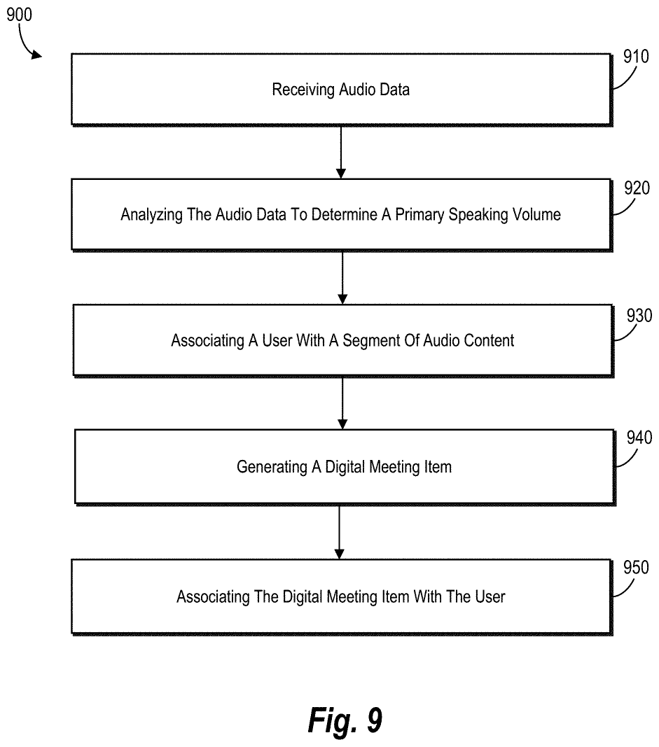

FIGS. 1-8, the corresponding text, and the examples provide a number of different methods, systems, devices, and non-transitory computer readable media of speaker attribution system 106. In addition to the foregoing, one or more embodiments can also be described in terms of flowcharts including acts for accomplishing a particular result, as shown in FIG. 9. FIG. 9 may be performed with more or fewer acts. Further, the acts may be performed in different order. Additionally, the acts described herein may be repeated or performed in parallel with one another or in parallel with different instances of the same or similar acts.

As mentioned, FIG. 9 illustrates a flowchart of series of acts 900 for associating a digital meeting item with a user associated with a meeting in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. For example, in some embodiments, the acts of FIG. 9 are performed as part of a computer-implemented method. Alternatively, a non-transitory computer readable medium (e.g., a non-transitory computer readable storage medium) can include instructions that, when executed by at least one processor, cause a computing device to perform the acts of FIG. 9. In some embodiments, a system can perform the acts of FIG. 9. For example, in one or more embodiments, a system includes at least one processor and at least one non-transitory computer readable storage medium including instructions that, when executed by the at least one processor, cause the system to perform the acts of FIG. 9.

Series of acts 900 includes act 910 of receiving audio data. For example, act 910 involves receiving, by a digital content management system, audio data from a plurality of client devices, the audio data including audio content associated with a meeting. In one or more embodiments, the audio data further includes volume data corresponding to the audio content. For example, the audio data can further include a time-based record of volume detected by the first client device. In some embodiments, receiving the audio data from the plurality of client devices includes receiving a first set of audio data from the first client device; and receiving a second set of audio data form the second client device.

Series of acts 900 also includes act 920 of analyzing the audio data to determine a primary speaking volume. For example, act 920 involves analyzing, by the digital content management system, the audio data to determine a primary speaking volume associated with a first client device of the plurality of client devices. In one or more embodiments, analyzing the audio data to determine the primary speaking volume associated with the first client device includes analyzing volume data to determine the primary speaking volume. For example, analyzing the audio data to determine the primary speaking volume associated with the first client device can include analyzing a time-based record of volume to determine the primary speaking volume.

In some embodiments, analyzing the audio data to determine a primary speaking volume associated with the first client device of the plurality of client devices includes comparing a plurality of speaking volumes associated with the audio data to determine a primary speaking volume associated with a first client device of the plurality of client devices. More specifically, analyzing the audio data to determine a primary speaking volume associated with the first client device of the plurality of client devices can include comparing a plurality of speaking volumes detected by the first client device; and identifying a highest speaking volume as the primary speaking volume based on comparing the plurality of speaking volumes. In one or more embodiments, comparing the plurality of speaking volumes associated with the audio data to determine the primary speaking volume associated with the first client device includes comparing speaking volumes associated with a first set of audio data (received from the first client device) to determine the primary speaking volume associated with the first client device.

Series of acts 900 further includes act 930 of associating a user with a segment of audio content. For example, act 930 involves associating, by the digital content management system, a first user of the first client device with a segment of the audio content based on the primary speaking volume associated with the first client device. In some embodiments, associating the first user of the first client device with a segment of the audio content based on the primary speaking volume associated with the first client device includes identifying a segment of the audio content corresponding to the primary speaking volume; and associating the segment of the audio content with the first user of the first client device.

In one or more embodiments, speaker attribution system 106 further receives, from a computer application installed on the first client device, an authentication of the first user. For example, speaker attribution system 106 can receive an authentication of the first user generated by submission of one or more login credentials by the first user via the first client device. Accordingly, associating the first user with the segment of the audio content can be further based on the authentication of the first user.

In some embodiments, speaker attribution system 106 further receives video data from the plurality of client devices, the video data including video content associated with the meeting. Speaker attribution system 106 can analyze the video content to identify the first user. For example, in one or more embodiments, analyzing the video content to identify the first user includes utilizing a facial recognition model to determine an identity of the first user based on the video content. Accordingly, associating the first user with the segment of the audio content can be further based on analyzing the video content to identify the first user.

Additionally, series of acts 900 includes act 940 of generating a digital meeting item. For example, act 940 involves generating, by the digital content management system, a digital meeting item based on a transcript of the segment of the audio content. In one or more embodiments, the digital meeting item includes at least one of a meeting transcript of the audio content associated with the meeting; a participation report including participation details corresponding to one or more users associated with the meeting; an action item; a notification; or a calendar item.

As an example, in one or more embodiments, the digital meeting item includes the participation report. Speaker attribution system 106 track participation data corresponding to the first user based on the segment of the audio content. Accordingly, generating the digital meeting item can include generating a participation report based on the participation data. In one or more embodiments, the participation data includes at least one of a length of time spoken by the first user or a number of interruptions by the first user.

In some embodiments, generating the digital meeting item includes analyzing a transcript of the segment of the audio content to identify text representing speech included in the segment of the audio content; and generating the digital meeting item based on the text corresponding to the segment of the audio content.

Further series of acts 900 includes act 950 of associating the digital meeting item with the user. For example, act 950 involves associating, by the digital content management system, the digital meeting item with the first user based on associating the first user with the segment of the audio content. In one or more embodiments, associating the digital meeting item with the first user includes providing the digital meeting item for display on the first client device.

As an example, the digital meeting item can include a meeting transcript. Accordingly, associating the digital meeting item with the first user can include generating an identification tag corresponding to the first user; and modifying the meeting transcript by associating the identification tag with the segment of the audio content.

As another example, the digital meeting item can include an action item. Accordingly, associating the digital meeting item with the first user can include generating an action item prompt to complete the action item; and providing the action item prompt for display on the first client device.

In one or more embodiments, series of acts 900 further includes acts for associating a digital meeting item with a second user associated with a meeting. For example, in one or more embodiments, the acts can include analyzing the audio data to determine a second primary speaking volume associated with a second client device of the plurality of client devices; and associating a second user of the second client device with an additional segment of the audio content based on the second primary speaking volume associated with the second client device. In such embodiments, generating the digital meeting item can be further based on an additional transcript of the additional segment of the audio content.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of example computing device 1000 that may be configured to perform one or more of the processes described above. One will appreciate that one or more computing devices, such as computing device 1000 may represent the computing devices described above (e.g., server(s) 102, client devices 112a-112n, and third-party system 108). In one or more embodiments, computing device 1000 may be a mobile device (e.g., a mobile telephone, a smartphone, a PDA, a tablet, a laptop, a camera, a tracker, a watch, a wearable device, etc.). In some embodiments, computing device 1000 may be a non-mobile device (e.g., a desktop computer or another type of client device). Further, computing device 1000 may be a server device that includes cloud-based processing and storage capabilities.

As shown in FIG. 10, computing device 1000 can include one or more processor(s) 1002, memory 1004, storage device 1006, input/output interfaces 1008 (or “I/O interfaces 1008”), and communication interface 1010, which may be communicatively coupled by way of a communication infrastructure (e.g., bus 1012). While computing device 1000 is shown in FIG. 10, the components illustrated in FIG. 10 are not intended to be limiting. Additional or alternative components may be used in other embodiments. Furthermore, in certain embodiments, computing device 1000 includes fewer components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or storage device 1006 and decode and execute them.

Computing device 1000 includes memory 1004, which is coupled to processor(s) 1002. Memory 1004 may be used for storing data, metadata, and programs for execution by the processor(s). Memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. Memory 1004 may be internal or distributed memory.

Computing device 1000 includes storage device 1006, which includes storage for storing data or instructions. As an example, and not by way of limitation, storage device 1006 can include a non-transitory storage medium described above. Storage device 1006 may include a hard disk drive (HDD), flash memory, a Universal Serial Bus (USB) drive or a combination these or other storage devices.

As shown, computing device 1000 includes one or more I/O interfaces 1008, which are provided to allow a user to provide input to (such as user strokes), receive output from, and otherwise transfer data to and from computing device 1000. I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

Computing device 1000 can further include communication interface 1010. Communication interface 1010 can include hardware, software, or both. Communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. Computing device 1000 can further include bus 1012. Bus 1012 can include hardware, software, or both that connects components of computing device 1000 to each other.

FIG. 11 is a schematic diagram illustrating an environment within which one or more embodiments of content management system 104 can be implemented. Online content management system 1102 may generate, store, manage, receive, and send digital content (such as digital videos). For example, online content management system 1102 may send and receive digital content to and from client devices 1106 by way of network 1104. In particular, online content management system 1102 can store and manage a collection of digital content. Online content management system 1102 can manage the sharing of digital content between computing devices associated with a plurality of users. For instance, online content management system 1102 can facilitate a user sharing a digital content with another user of online content management system 1102.

In particular, online content management system 1102 can manage synchronizing digital content across multiple client devices 1106 associated with one or more users. For example, a user may edit digital content using client device 1106. Online content management system 1102 can cause client device 1106 to send the edited digital content to online content management system 1102. Online content management system 1102 then synchronizes the edited digital content on one or more additional computing devices.

In addition to synchronizing digital content across multiple devices, one or more embodiments of online content management system 1102 can provide an efficient storage option for users that have large collections of digital content. For example, online content management system 1102 can store a collection of digital content on online content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from online content management system 1102. In particular, upon a user selecting a reduced-sized version of digital content, client device 1106 sends a request to online content management system 1102 requesting the digital content associated with the reduced-sized version of the digital content. Online content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1106 may execute one or more client applications, such as a web browser (e.g., MICROSOFT WINDOWS INTERNET EXPLORER, MOZILLA FIREFOX, APPLE SAFARI, GOOGLE CHROME, OPERA, etc.) or a native or special-purpose client application (e.g., DROPBOX PAPER for IPHONE or IPAD, DROPBOX PAPER for ANDROID, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access collaborative content management system 1102.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
receiving, by a digital content management system, audio data from a plurality of client devices, the audio data comprising audio content associated with a meeting, wherein the audio content associated with a first client device of the plurality of client devices comprises speech from a plurality of participants of the meeting;
analyzing, by the digital content management system, the audio data associated with the first client device by comparing speaking volumes of the speech from the plurality of participants to determine a primary speaking volume associated with the first client device;
associating, by the digital content management system, a first user of the first client device with a segment of the audio content based on the primary speaking volume associated with the first client device;
generating, by the digital content management system, a digital meeting item based on a transcript of the segment of the audio content; and
associating, by the digital content management system, the digital meeting item with the first user based on associating the first user with the segment of the audio content.

2. The computer-implemented method of claim 1, wherein:
the audio data further comprises a time-based record of volume detected by the first client device; and
analyzing the audio data to determine the primary speaking volume associated with the first client device comprises analyzing the time-based record of volume to determine the primary speaking volume.

3. The computer-implemented method of claim 1, wherein analyzing the audio data associated with the first client device by comparing the speaking volumes of the speech from the plurality of participants to determine the primary speaking volume associated with the first client device comprises:
identifying a highest speaking volume as the primary speaking volume based on comparing the speaking volumes of the speech from the plurality of participants.

4. The computer-implemented method of claim 1,
further comprising receiving, from a computer application installed on the first client device, an authentication of the first user,
wherein associating the first user with the segment of the audio content is further based on the authentication of the first user.

5. The computer-implemented method of claim 1, further comprising:
receiving video data from the plurality of client devices, the video data comprising video content associated with the meeting; and
analyzing the video content to identify the first user,
wherein associating the first user with the segment of the audio content is further based on analyzing the video content to identify the first user.

6. The computer-implemented method of claim 5, wherein analyzing the video content to identify the first user comprises utilizing a facial recognition model to determine an identity of the first user based on the video content.

7. The computer-implemented method of claim 1, wherein the digital meeting item comprises at least one of:
a meeting transcript of the audio content associated with the meeting;
a participation report comprising participation details corresponding to one or more users associated with the meeting;
an action item;
a message;
a notification; or
a calendar item.

8. The computer-implemented method of claim 7, wherein:
the digital meeting item comprises the meeting transcript; and
associating the digital meeting item with the first user comprises:
generating an identification tag corresponding to the first user; and
modifying the meeting transcript by associating the identification tag with the segment of the audio content.

9. The computer-implemented method of claim 7, wherein:
the digital meeting item comprises the action item; and
associating the digital meeting item with the first user comprises:
generating an action item prompt to complete the action item; and
providing the action item prompt for display on the first client device.

10. The computer-implemented method of claim 1, further comprising:
analyzing the audio data to determine a second primary speaking volume associated with a second client device of the plurality of client devices; and
associating a second user of the second client device with an additional segment of the audio content based on the second primary speaking volume associated with the second client device,
wherein generating the digital meeting item is further based on an additional transcript of the additional segment of the audio content.

11. A non-transitory computer readable storage medium comprising instructions that, when executed by at least one processor, cause a computing device to:
receive audio data from a plurality of client devices, the audio data comprising audio content associated with a meeting, wherein the audio content associated with a first client device of the plurality of client devices comprises speech from a plurality of participants of the meeting;
analyze the audio data associated with the first client device by comparing speaking volumes of the speech from the plurality of participants to determine a primary speaking volume associated with the first client device;
associate a first user of the first client device with a segment of the audio content based on the primary speaking volume associated with the first client device;
analyze a transcript of the segment of the audio content to identify text representing speech from the segment of the audio content;
generate a digital meeting item based on the text corresponding to the segment of the audio content; and
associate the digital meeting item with the first user based on associating the first user with the segment of the audio content.

12. The non-transitory computer readable storage medium of claim 11, wherein:
the audio data further comprises volume data corresponding to the audio content; and
the instructions, when executed by the at least one processor, cause the computing device to analyze the audio data to determine the primary speaking volume associated with the first client device comprises analyzing the volume data to determine the primary speaking volume.

13. The non-transitory computer readable storage medium of claim 11,
further comprising instructions that, when executed by the at least one processor, cause the computing device to track participation data corresponding to the first user based on the segment of the audio content,
wherein the instructions, when executed by the at least one processor, cause the computing device to generate the digital meeting item by generating a participation report based on the participation data.

14. The non-transitory computer readable storage medium of claim 13, wherein the participation data includes at least one of a length of time spoken by the first user or a number of interruptions by the first user.

15. The non-transitory computer readable storage medium of claim 11, wherein the instructions, when executed by the at least one processor, cause the computing device to associate the digital meeting item with the first user by providing the digital meeting item for display on the first client device.

16. The non-transitory computer readable storage medium of claim 11,
further comprising instructions that, when executed by the at least one processor, cause the computing device to receive, from a computer application installed on the first client device, an authentication of the first user generated by submission of one or more login credentials by the first user via the first client device,
wherein the instructions, when executed by the at least one processor, cause the computing device to associate the first user with the segment of the audio content further based on the authentication of the first user.

17. A system comprising:
at least one processor; and
a non-transitory computer readable storage medium comprising instructions that, when executed by the at least one processor, cause the system to:
receive audio data from a plurality of client devices, the audio data comprising audio content associated with a meeting, wherein the audio content associated with a first client device of the plurality of client devices comprises speech from a plurality of participants of the meeting;
compare a plurality of speaking volumes of the speech from the plurality of participants to determine a primary speaking volume associated with the first client device;
identify a segment of the audio content corresponding to the primary speaking volume;
associate the segment of the audio content with a first user of the first client device;
generate a digital meeting item based on a transcript of the segment of the audio content; and
associate the digital meeting item with the first user based on associating the first user with the segment of the audio content.

18. The system of claim 17, wherein the instructions, when executed by the at least one processor, cause the system to generate the digital meeting item based on the transcript of the segment of the audio content by:
analyzing the transcript of the segment of the audio content to identify text representing speech included in the segment of the audio content; and
generating the digital meeting item based on the text corresponding to the segment of the audio content.

19. The system of claim 18, wherein the instructions, when executed by the at least one processor, causes the system to receive the audio data from the plurality of client devices by:
receiving a first set of audio data from the first client device; and
receiving a second set of audio data from a second client device.

20. The system of claim 19, wherein the instructions, when executed by the at least one processor, cause the system to compare the plurality of speaking volumes associated with the audio data to determine the primary speaking volume associated with the first client device by comparing speaking volumes associated with the first set of audio data to determine the primary speaking volume associated with the first client device.
